(19) United States
(12) Patent Application Publication
(10) Pub. No.: US 2006/0095494 A1
(43) Pub. Date: May 4, 2006

(54) Method and apparatus for efficient software-based integer division

(76) Inventor: Alok Kumar, Santa Clara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/975,319

(22) Filed: Oct. 28, 2004

(51) Int. Cl. G06F 7/38

(52) U.S. Cl. 708/502

(57) ABSTRACT

A method and apparatus to perform efficient software-based integer division. The equivalent of a hardware-based integer division operation is enabled via a reciprocal multiplication operation that is facilitated by a minimum combination of multiplication (and/or add) and shift operations. Properties and equations are derived for determining minimum multiplication and shift instructions to perform an integer division of a variable dividend and constant divisor using reciprocal multiplication. Computer functions are disclosed for determining parameters from which the minimum multiplication and shift instructions can be derived. Software/firmware is then coded employing the minimum multiplication and shift instructions to perform software-based integer division operations via reciprocal multiplication. In one embodiment, the integer division operations are employed to determine a minimum number of cells required to store the data in a packet or frame that is processed by a network processor.

### FIELD OF THE INVENTION

The field of invention relates generally to performing division operations using processing components and, more specifically but not exclusively relates to techniques for performing efficient software-based integer division using reciprocal multiplication.

### BACKGROUND INFORMATION

Network devices, such as switches and routers, are designed to forward network traffic, in the form of packets, at high line rates. One of the most important considerations for handling network traffic is packet throughput. To accomplish this, special-purpose processors known as network processors have been developed to efficiently process very large numbers of packets per second. In order to process a packet, the network processor (and/or network equipment employing the network processor) needs to extract data from the packet header indicating the destination of the packet, class of service, etc., store the payload data in memory, perform packet classification and queuing operations, determine the next hop for the packet, select an appropriate network port via which to forward the packet, perform packet and cell framing/deframing operations etc. These operations are generally referred to as “packet processing” operations.

Modern network processors perform packet processing using multiple multi-threaded processing elements (referred to as microengines or compute engines in network processors manufactured by Intel® Corporation, Santa Clara, Calif.), wherein each thread performs a specific task or set of tasks in a pipelined architecture. During packet processing, numerous accesses are performed to move data between various shared resources coupled to and/or provided by a network processor. For example, network processors commonly store packet metadata and the like in external static random access memory (SRAM) stores, while storing packets (or packet payload data) in external dynamic random access memory (DRAM)-based stores. Thus, the network processor provides SRAM and DRAM interfaces. In addition, a network processor may include cryptographic processors, hash units, general-purpose processors, and expansion buses, such as a PCI (peripheral component interconnect) and PCI Express bus. All of these interfaces consume silicon real estate.

In general, the various packet-processing compute engines of a network processor, as well as other optional processing elements, will function as embedded specific-purpose processors. In contrast to conventional general-purpose processors used in desktop computers and the like, the compute engines do not employ an operating system to host applications, but rather directly execute “application” code (sometimes referred to as “microcode”) using a reduced instruction set. For example, the microengines in Intel's® IXP2xxx family of network processors are 32-bit RISC (reduced instruction set computer) processors that employ an instruction set including conventional RISC instructions with additional features specifically tailored for network processing. Since microengines are not general-purpose processors, many tradeoffs are made to minimize their size and power consumption.

One of the tradeoffs relates to instruction capabilities. A reduced instruction set computer is just that—it has a reduced number of instructions in its instruction set when compared with more conventional CISC (complex instruction set computer) processors. Generally, the RISC instruction set is targeted for specific operations, providing higher performance for those operations when compared with corresponding CISC instructions. For network processors, the compute engine instruction set typically includes instructions relating to memory access and general data manipulation operations, for example. However, many operations that may be performed via a single or multiple CISC instructions are not supported by the compute engines. One of these is integer division. One reason for this is because there a significant amount of extra circuitry required to support hardware-based integer division. When considering that a typical network processor might include 8, 16 or even more compute engines, the “cost” (in terms of silicon real-estate and fabrication) of adding this extra circuitry for each compute engine is too high. In view of this deficiency, integer division is done through software.

There are various known techniques for performing integer division via software. The length of the corresponding functions (and thus processing latency) general vary depending on the capabilities of the instruction set for the processing element. As might be expected, CISC processors typically enable software-based integer division via less instructions than RISC processors. Thus, the conventional functions used to perform software-based integer division on RISC-based compute engines are fairly lengthy.

This poses two problems. First, a longer function requires longer processing latency. This eats into the overall processing latency budget for performing line-rate packet processing. Second, a longer function requires more instruction storage space. Since the code space for compute engines is typically quite small (e.g., the control store for an Intel IXP1200 holds 2K instruction words, while the IXP2400 holds 4K instructions words, and the IXP2800 holds 8K instruction words), it is advantageous to employ as space-efficient code as possible.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 shows a code listing corresponding to an function for determining parameters for performing a software-based integer division operation using reciprocal multiplication, wherein minimum multiplication and shift instructions are used, according to one embodiment of the invention;

FIG. 2 shows a code listing corresponding to an function for determining parameters for performing a software-based integer division operation using reciprocal multiplication, wherein minimum multiplication and shift instructions are used, according to another embodiment of the invention;

FIG. 3 is a flowchart illustrating operations performed to determine parameters employed for reciprocal multiplication operations via the use of one or both of the functions shown in FIGS. 1 and 2, and further includes operations for programming, storing and loading the code to perform the reciprocal multiplication operations;

FIG. 4 is a code segment showing pseudocode to determine a minimum number of cells that are required to store data contained in a variable-size packet being processed by a network processor; and

FIG. 5 is a schematic diagram of a network line card employing a network processor that execute threads to process network packets, wherein a portion of the threads employ microcode to perform software-based integer division via reciprocal multiplication.

### DETAILED DESCRIPTION

Embodiments of methods and apparatus for efficient software-based integer division are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

During packet processing operations, it is often necessary or advantageous to perform integer division operations. For example, a packet or frame having a particular size may need to broken up into smaller size units, such as cells or packets. Typically, the cell, or packet size is fixed, such as the fixed size for ATM (Asynchronous Transfer Mode) cells. Under such circumstances, the divisor (e.g., cell size in this example) is known in advance, and thus is a constant. Meanwhile, the packet or frame size may be used as a variable dividend that will not be known until being processed. However, a reasonable limit for the packet or frame size can usually be determined.

Given that divisor is a constant and placing some restriction on the range of values for the dividend, the division can be approximated by a multiplication and a shift instruction. This method, called “reciprocal multiplication”, is known in the art. However, under existing practice, there is no deterministic method available to find the minimal multiplier and the shift instruction that will give the exact same result as the corresponding mathematical integer division.

Accordingly, embodiments of the present invention are described herein that produce a minimum multiplier and shift instruction to produce the equivalent result as a corresponding integer division operation. Furthermore, proofs are provided to show why the multiplier and shift instruction will produce the same result, and why the multiplier is the minimum multiplier to produce this result.

If we need to divide a variable integer x by a given constant integer C, then
floor(x/C) is an integer f iff x=f*C+k₀, where k₀ is an integer and 0≦k₀<C. (1)
and
ceil(x/C) is an integer c iff x=c*C−k₁, where k₀ is an integer and 0≦k₁<C. (2)
In equation 1, floor(x/C) employs the floor(y) function, which in mathematics is used to define the largest integer less than or equal to the real number y (x/C in this instance)) operated on by the function. Meanwhile, ceil(x/C) in equation 2 employs the ceil(y) or ceiling(y) function, which in mathematics states for any given real numbery, ceiling(y) is the smallest integer no less than y.

Given some restriction on the range of value of x, floor(x/C) may be calculated using add, multiply and shift operations in the following manner.

$$\begin{matrix}x / C = x * \frac{{2}^{″} / C}{{2}^{n}} & ( 3 a ) \\ x / C = x * \frac{K}{{2}^{n}} & ( 3 b )\end{matrix}$$

where K=2ⁿ/C.

We now introduce a new function, approx(x/C), which represents an approximate integer value for x/C, as follows:

$$approx ( x / C ) = x * \frac{ceil ( K )}{{2}^{n}} \qquad ( 4 )$$

approx(x/C) will be the result of reciprocal multiplication to calculate floor function (1). We need to ensure the following property P1 is true to ensure the result of the reciprocal multiplication will yield the exact same integer result as normal division:
floor(x/C)=floor(approx(x/C)) (P1).
To ensure property P1 is true, we need to ensure that
x/C≦approx(x/C)<(x+1)/C (P2).
(A proof that shows property P2 is a necessary and sufficient property to satisfy property P1 is provided below in the attached Appendix.)

Continuing,

x/C≦approx(x/C) can be shown, as follows:

$$approx ( x / C ) = x * \frac{ceil ( K )}{{2}^{n}} \geq x * \frac{K}{{2}^{n}} = x / C \qquad ( 5 )$$

Therefore, approx(x/C)≧x/C.

Now, let's define a new function diff,
diff=(x+1)/C−approx(x/C) (6)
Then,
diff=(x+1)/C−(x*ceil(K)/2ⁿ) (6a)
diff=1/C−x*(ceil(K)/2ⁿ−1/C)) (6b)
diff=1/C−x*δ (6c)
where

δ=(ceil(K)/2ⁿ−1/C)=(ceil(K)−K)/2ⁿ

It is noted that we can make δ arbitrarily small by increasing value of n.

If x can take a value from 0 to max_x, then
diff>1/C−max_{—}x*δ (7)

If diff>0, then property P2 will be true. Therefore, to meet property P2, we need to ensure that diff>0.
1/C−max_{—}x*delta>0 [symbol]
max_{—}x*δ<1/C [symbol]
δ<1/(C*max_{—}x) [symbol]
(ceil(K)−K)/2ⁿ<1(C*max_{—}x) [symbol]
2ⁿ/(ceil(K)−K)>C*max_{—}x (P3)

n can be calculated to meet property P3. Further it is proven below that a value of n can always be found. First, the upper bound for the value of n is determined in the following manner:

Note,
(ceil(K)−K)<1.
Therefore, property P3 can be ensured by
2ⁿ>(C*max_{—}x). (8a) [symbol]
n>log 2(C*max_{—}x). (8b) [symbol]
n=ceil(log 2(C*max_{—}x)). (8c)

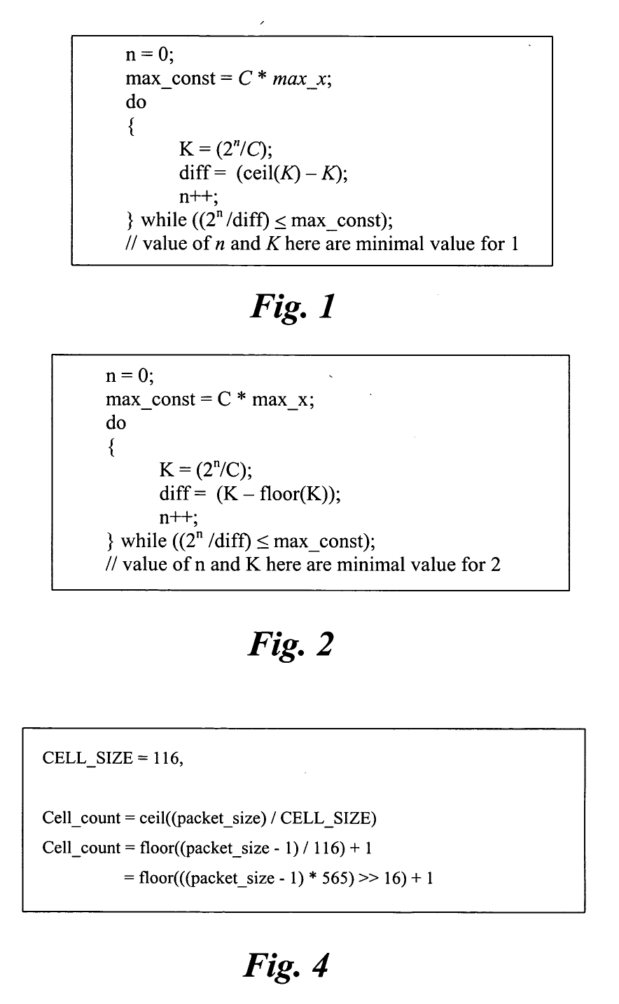

It is easy to calculate n to meet property P3 using the function shown in FIG. 1 and we have shown that an upper bound on the value of n is ceil(log 2(C* max_x)). After calculating the value of n, floor(x/C) can be calculated using:

$$\begin{matrix}floor ( x / C ) = floor ( approx ( x / C ) ) & ( 9 a ) \\ = floor ( x * ceil ( {2}^{n} / C ) / {2}^{n} ) & ( 9 b ) \\ = floor ( x * ceil ( K ) / {2}^{n} ) \\ = ( x * ceil ( K ) ) >> n f or 0 < x < max\_x . & ( 9 c )\end{matrix}$$

Integer multiplication can be implemented via a multiplication instruction if such an instruction is available in the compute engine instruction set. If not, integer multiplication can be simulated by using shift and add operations. Additionally, division by 2ⁿ can be performed using a simple shift operations. Similarly, we can show that if,

$$\begin{matrix}{2}^{n} / ( K - floor ( K ) ) > C * max\_x \\ then & ( 10 ) \\ ceil ( x / C ) = ceil ( x * floor ( {2}^{n} / C ) / {2}^{n} ) & ( 11 A ) \\ = ceil ( x * floor ( K ) {2}^{n} ) . & ( 11 B )\end{matrix}$$

(Proof shown in Proof 2 of Appendix).

To summarize the foregoing results,

1. floor(x/C)=((x*ceil(K))>>n) for 0<x<max_x

iff(2ⁿ/(ceil(K)−K))>C*max_x

and

2. ceil(x/C)=(((x*floor(K)−1)>>n)+1) for 0<x<max_x

iff(2ⁿ/(K−floor(K)))>C*max_x,

where K=(2ⁿ/C)

Functions to Calculate Multiplier

Functions to find K and n for conditions 1 and 2, according to one embodiment, are shown in FIGS. 1 and 2, respectively, as well as below:

Listing 1.

n = 0;
max_const = C * max_x;
do
{

K = (2ⁿ/C);
diff = (ceil(K) − K);
n++;

} while ((2ⁿ/diff) ≦ max_const);
// value of n and K here are minimal value for 1

Listing 2.

n = 0;
max_const = C * max_x;
do
{

K = (2ⁿ/C);
diff = (K − floor(K));
n++;

} while ((2ⁿ/diff) ≦ max_const);
// value of n and K here are minimal value for 2

It is noted that the foregoing code listings represent selected portions of an actual program that is used to determine the values for n and K. For example, the code for entering the input values for C and max_x are contained elsewhere (not shown). In generally, this portion of the program will present an interface via which a user can enter max_x and C as input parameters.

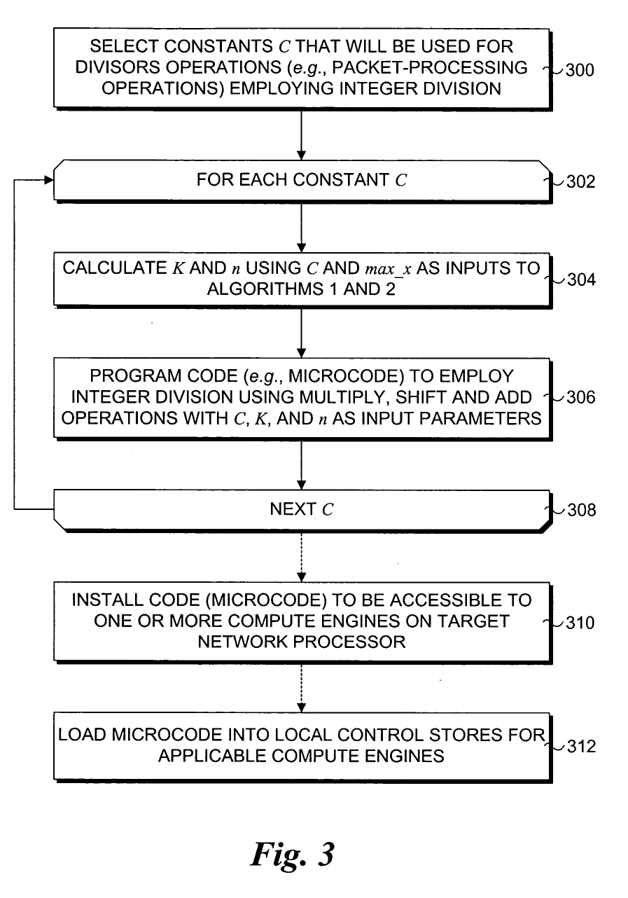

FIG. 3 shows a flowchart illustrating operations performed during an exemplary implementation of the integer division scheme, according to one embodiment of the invention. Overall, the implementation is targeted towards use on processing elements and the like that do not provide a built-in integer division operation. In particular, the exemplary implementation is directed towards use on a compute engine of a network processor. However, this is merely one example use of the technique.

The process begins in a block 300, wherein one or more constants C that are to be employed as divisors for integer division operations are selected. In view of the illustrated example, the constants pertain to divisors used in packet-processing operations employing integer division. In one embodiment, the packet-processing operations include dividing a packet or frame of variable size into a number of fixed-size cells. In this case, the objective is to determine the minimum number of cells required for the entire packet or frame. In addition to this exemplary use of a divisor constants, other constant may be selected as well.

As illustrated by start and end loop blocks 302 and 308, the operations depicted in blocks 304 and 306 are performed for each constant C. In block 304, K and n are calculated using C and max_x as inputs to either of functions 1 and 2 shown in FIGS. 1 and 2, respectively. In accordance with the foregoing cell division implementation, max_x represents the maximum size of the packet or frame, while C represents the cell size.

In one embodiment, the foregoing equations are employed for determining a number of cells a given packet will be divided into, as follows. For this exemplary case, the cell size is 116 Bytes (B), while the packet size may range from 1 to 9K bytes. Inserting 116 for C and 9K for x in property P3 yields n=16, which means that:

$$\begin{matrix}floor ( x / 116 ) = floor ( ( x * 565 ) / ( 2 ⋀ 16 ) ) \\ = ( x * 565 ) >> 16 for x \leq 9 K\end{matrix}$$

Once the values for K and n are calculated, software or firmware, such as microcode, is programmed in block 306 to employ a corresponding integer division operation using multiply and shift operations, wherein the code includes input parameters including C, K, and n. In general, the input parameters may be hard coded (e.g., constants defined by the code), or variables that are referenced by the code. For example, in one embodiment, the value for one or more of the parameters may be stored in a register or the like that is referenced by the code.

After the code for each constant C has been programmed, the code is installed on a storage device in a block 310 so as to be accessible to one or more compute engines on a target network processor. For example, the code may be written to a non-volatile storage device, such as a flash memory, local mass storage device (e.g., disk drive), or network storage resource. Subsequently, in a block 312, the code is loaded into the local control stores for applicable microengines to enable the code to be executed. In one embodiment, the local control stores are loaded during initialization of the network processor, as described below in further detail. The operations of blocks 304 and 306 are repeated, as necessary, for each constant C to be used for a corresponding integer division operation.

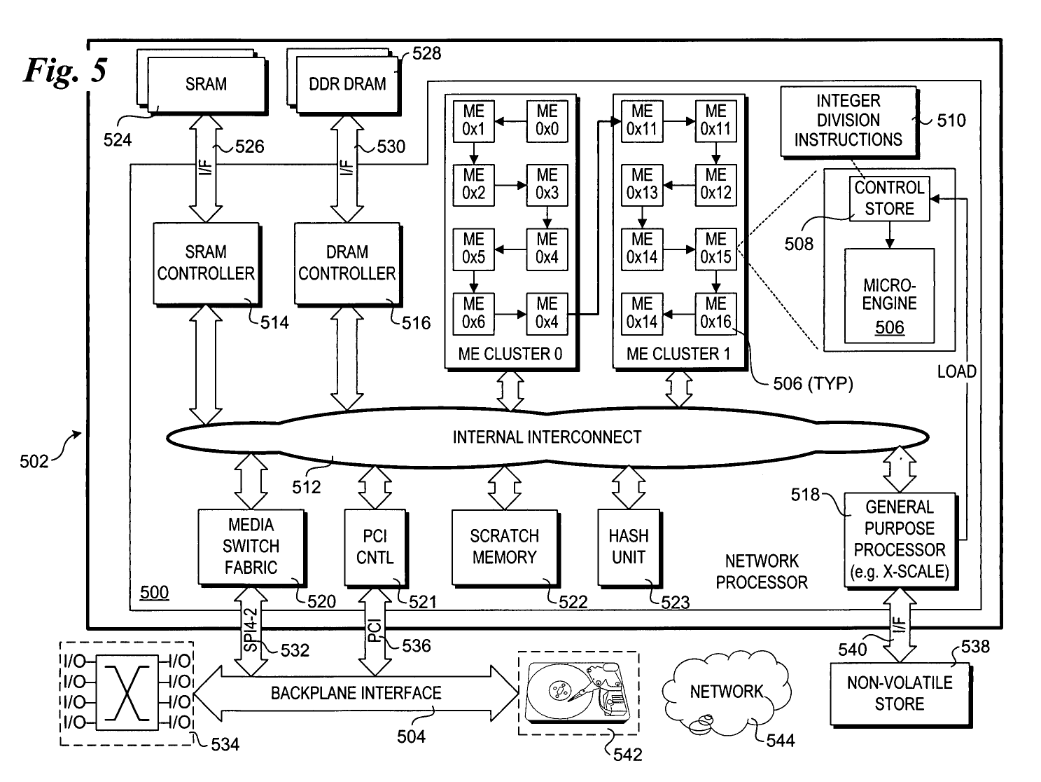

FIG. 4 shows a pseudocode listing corresponding to an integer division implementation that employs a cell size of 116B as a constant divisor. The first instance of Cell_count employs the ceil function discussed above. However it is noted that the same result for Cell_count can be obtained by employing the floor function of (packet_size−1) and adding 1 to it. Moreover, the integer division operation can be performed using a combination of an integer multiplication operation, followed by a bit shift operation and an addition operation. In the illustrated embodiment, the multiplicand is 565, with the multiplication result being shifted 16 bits to the right. 1 is then added to this result to produce the minimum number of cells needed to store the packet data.

FIG. 5 shows an exemplary implementation of a network processor 500 that includes one or more compute engines (e.g., microengines) that run instruction threads employing integer division via multiplication, shift, and add instructions using parameters derived via embodiments of the invention. In this implementation, network processor 500 is employed in a line card 502. In general, line card 502 is illustrative of various types of network element line cards employing standardized or proprietary architectures. For example, a typical line card of this type may comprises an Advanced Telecommunications and Computer Architecture (ATCA) modular board that is coupled to a common backplane in an ATCA chassis that may further include other ATCA modular boards. Accordingly the line card includes a set of connectors to meet with mating connectors on the backplane, as illustrated by a backplane interface 504. In general, backplane interface 504 supports various input/output (I/O) communication channels, as well as provides power to line card 502. For simplicity, only selected I/O interfaces are shown in FIG. 5, although it will be understood that other I/O and power input interfaces also exist.

Network processor 500 includes n microengines 506. In one embodiment, n=8, while in other embodiment n=16, 24, or 32. Other numbers of microengines 506 may also me used. In the illustrated embodiment, 16 microengines 506 are shown grouped into two clusters of 8 microengines, including an ME cluster 0 and an ME cluster 1.

In the illustrated embodiment, each microengine 506 executes instructions (microcode) that are stored in a local control store 508. Included among the instructions for one or more microengines are integer division instructions 510 that are derived in accordance with the embodiments discussed above. In one embodiment, the integer division instructions are written in the form of a microcode macro.

Each of microengines 506 is connected to other network processor components via sets of bus and control lines referred to as the processor “chassis”. For clarity, these bus sets and control lines are depicted as an internal interconnect 512. Also connected to the internal interconnect are an SRAM controller 514, a DRAM controller 516, a general purpose processor 518, a media switch fabric interface 520, a PCI (peripheral component interconnect) controller 521, scratch memory 522, and a hash unit 523. Other components not shown that may be provided by network processor 500 include, but are not limited to, encryption units, a CAP (Control Status Register Access Proxy) unit, and a performance monitor.

The SRAM controller 514 is used to access an external SRAM store 524 via an SRAM interface 526. Similarly, DRAM controller 516 is used to access an external DRAM store 528 via a DRAM interface 530. In one embodiment, DRAM store 528 employs DDR (double data rate) DRAM. In other embodiment DRAM store may employ Rambus DRAM (RDRAM) or reduced-latency DRAM (RLDRAM).

General-purpose processor 518 may be employed for various network processor operations. In one embodiment, control plane operations are facilitated by software executing on general-purpose processor 518, while data plane operations are primarily facilitated by instruction threads executing on microengines 506.

Media switch fabric interface 520 is used to interface with the media switch fabric for the network element in which the line card is installed. In one embodiment, media switch fabric interface 520 employs a System Packet Level Interface 4 Phase 2 (SPI4-2) interface 532. In general, the actual switch fabric may be hosted by one or more separate line cards, or may be built into the chassis backplane. Both of these configurations are illustrated by switch fabric 534.

PCI controller 522 enables the network processor to interface with one or more PCI devices that are coupled to backplane interface 504 via a PCI interface 536. In one embodiment, PCI interface 536 comprises a PCI Express interface.

During initialization, coded instructions (e.g., microcode) to facilitate the packet-processing functions and operations described above are loaded into control stores 508. In one embodiment, the instructions are loaded from a non-volatile store 538 hosted by line card 502, such as a flash memory device. Other examples of non-volatile stores include read-only memories (ROMs), programmable ROMs (PROMs), and electronically erasable PROMs (EEPROMs). In one embodiment, non-volatile store 538 is accessed by general-purpose processor 518 via an interface 540. In another embodiment, non-volatile store 538 may be accessed via an interface (not shown) coupled to internal interconnect 512.

In addition to loading the instructions from a local (to line card 502) store, instructions may be loaded from an external source. For example, in one embodiment, the instructions are stored on a disk drive 542 hosted by another line card (not shown) or otherwise provided by the network element in which line card 502 is installed. In yet another embodiment, the instructions are downloaded from a remote server or the like via a network 544 as a carrier wave.

In general, programs to implement the functions of FIGS. 1 and 2 may be stored on some form of machine-readable or machine-accessible media, and executed on some form of processing element, such as a microprocessor or the like. Thus, embodiments of this invention may be used as or to support a software program executed upon some form of processing core (such as the CPU of a computer) or otherwise implemented or realized upon or within a machine-readable or machine-accessible medium. A machine-accessible medium includes any mechanism for storing or transmitting information in a form readable by a machine (e.g., a computer). For example, a machine-accessible medium can include such as a read only memory (ROM); a random access memory (RAM); a magnetic disk storage media; an optical storage media; and a flash memory device, etc. In addition, a machine-accessible medium can include propagated signals such as electrical, optical, acoustical or other form of propagated signals (e.g., carrier waves, infrared signals, digital signals, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

### Appendix

Proof 1. Proof to show property P2 implies property P1.
x/C≦approx(x/C) [symbol]
floor(x/C)≦floor(approx(x/C)) [symbol]
floor(x/C)≦floor(approx(x/C)) (P2a)
approx (x/C)<(x+1)/C

Let x=f*C+k; where 0≦k≦C

Then floor(x/C)=f
x+1=f*C+k+1 [symbol]
(x+1)=j*C+k+1 [symbol]
(x+1)/C=f+(k+1)/C [symbol]
approx(x/C)<f+(k+1)/C [symbol]
approx(x/C)<f+1 [symbol]
floor(approx(x/C))<f+1 [symbol]
floor(approx(x/C)≦f [symbol]
floor(approx(x/C)≦floor(x/C) (P2b)

Combining properties P2a and P2b results in property 1: Therefore, the property 2 is sufficient to prove property 1.

It can also be shown that property P2 is necessary to prove property P1, as follows.

If property 2 is not true, then

Either
x/C>approx (x/C) (P2c)
or
approx(x/C)≧(x+1)/C (P2d)
if (2c) is true, then for an x=f*C,

then floor(x/C)=f, and

approx(x/C)<(f*C)/C

[symbol] floor(approx(x/C))≦f−1

[symbol] Therefore, property P1 is not true

If (2d) is true, then for x+1=f*C

Then floor(x/C)=f−1

However, approx(x/C)≧(x+1)/C

[symbol] floor(approx(x/C))≧f>floor(x/C)

[symbol] Therefore, property P1 is not true

Therefore, if property P2 is not true, then property P1 is not true. This proves that property P2 is a necessary and sufficient condition for the property P1.

Proof 2.

We will describe how to calculate ceil(x/C) using add, multiply and shift operations given some restriction on the range of value of x.

$$\begin{matrix}x / C = x * ( {2}^{n} / C ) / {2}^{n} , where n is any integer . \\ = x * K / {2}^{n}\end{matrix}$$

$$where K = {2}^{n} / C$$

We will call approx(x/C)=x*floor(K)/2ⁿ

We need to ensure:
ceil(x/C)=ceil(approx(x/C)) (P4)

To ensure property 1, we need to ensure that:
(x−1)/C<approx(x/C)≦x/C (P5)

Proof to show property P5 is necessary and sufficient is shown in proof 3 below.

$$x / C \geq approx ( x / C ) is trivial , since$$

$$approx ( x / C ) = x * floor ( K ) / {2}^{n} \leq x * K / {2}^{n} = x / C$$

$$Therefore , approx ( x / C ) \leq x / C$$

$$Lets define diff = approx ( x / C ) - ( x - 1 ) / C$$

$$\begin{matrix}diff = ( x * floor ( K ) / {2}^{n} ) - ( x - 1 ) / C \\ = 1 / C - x * ( 1 / C - floor ( K ) / {2}^{n} ) ) \\ = 1 / C - x * δ ,\end{matrix}$$

$$where$$

$$\begin{matrix}δ = ( 1 / C - floor ( K ) / {2}^{n} ) \\ = ( K - floor ( K ) ) / {2}^{n}\end{matrix}$$

We should note that we can make δ arbitrarily small by increasing value of n.

If x can take value 0 to max_x

Then, diff>1/C−max_x*δ

If diff>0, then property P5 will be true.

Therefore, to meet property P5, we need to ensure that diff>0 [symbol]
1/C−max_{—}x*delta>0 [symbol]
max_{—}x*delta<1/C [symbol]
delta<1/(C*max_{—}x) [symbol]
(K−floor(K))/2ⁿ<1/(C*max_{—}x) [symbol]
2ⁿ/(K−floor(K))>C*max_{—}x (P6)

We can calculate n to meet property P6. Further, we prove that a value of n can always be found. We find an upper bound of value of n.

Please, note that (K−floor(K))<1. Therefore, property P6 can be ensured by
2ⁿ>(C*max_{—}x). [symbol]
n>log 2(C*max_{—}x). [symbol]
n=ceil(log 2(C*max_{—}x))

It is easy to calculate n to meet property P6 and we have shown that an upper bound on the value of n is ceil(log 2(C*max_x)). After calculating the value of n,

$$ceil ( x / C ) can be calculated using$$

$$\begin{matrix}ceil ( x / C ) = ceil ( approx ( x / C ) ) \\ = ceil ( x * floor ( {2}^{n} / C ) / {2}^{n} ) \\ = ceil ( x * floor ( K ) / {2}^{n} )\end{matrix}$$

$$for 0 < x < max\_x$$

Proof 3.

Proof to show property P5 implies property P4 follows.
x/C≧approx(x/C) [symbol]
ceil(x/C)≧ceil(approx(x/C)) [symbol]
ceil(x/C)≧ceil(approx(x/C)) (P5a)

approx(x/C)>(x−1)/C

Let x=f*C−k; where 0≦k<C

Then ceil(x/C)=f
x−1=f*C−(k+1) [symbol]
(x−1)=f*C−(k+1) [symbol]
(x−1)/C=f−(k+1)/C [symbol]
approx(x/C)>f−(k+1)/C [symbol]
approx(x/C)>f−1 [symbol]
ceil(approx(x/C))>f−1
ceil(approx(x/C)≧f [symbol]
ceil(approx(x/C)≧ceil(x/C) (P5b)

Combining P5a and P5b results in property P5. Therefore, the property P5 is sufficient to prove property P4.

It can also be shown that property P5 is necessary to prove property P4.

Proof is as Follows.

If property P5 is not true, then
Either
x/C<approx(x/C) (P5c)
or
approx(x/C)≦(x−1)/C (P5d)

if (P5c) is true, then for an x=f*C,

then ceil(x/C)=f and

approx(x/C)>f*C/C

[symbol] ceil(approx(x/C))≧f+1

[symbol] Therefore, property P4 is not true

If (5d) is true, then for x−1=f*C

Then ceil(x/C)=f+1

However, approx(x/C)≦(x−1)/C

[symbol] ceil(approx(x/C))≦f<ceil(x/C)

[symbol] property P4 is not true

Therefore, if property P5 is not true, then property P5 is not true. This proves that property P5 is a necessary and sufficient condition for the property P4.

What is claimed is:

1. A method comprising:
determining a constant to be used as a divisor in an integer division operation having a variable dividend in a pre-defined range;
determining parameters to be employed in a combination of multiplication, shift, and optional add operations on a processing element to perform the integer division operation, the parameters including a minimal multiplier and shift instruction to produce the same result as a corresponding mathematical integer division operation on the variable dividend using the constant divisor.

2. The method of claim 1, further comprising:
programming code to be executed on the processing element to perform the integer division operations using multiplication, shift and optional add instructions, the code employing the parameters that are determined.

3. The method of claim 2, wherein the code is to be executed on one or more compute engines that do not provide a built-in integer division operation, the method further comprising:
storing the code that is programmed to be accessible to the one or more compute engines.

4. The method of claim 3, wherein the compute engines are part of a network processor, and the code is used to perform an integer division operation pertaining to network packet processing.

5. The method of claim 4, wherein the integer division operation pertains to determining a minimum number of fixed-size cells a packet or frame of variable size may be divided into.

6. The method of claim 2, further comprising hard-coding the parameters as constants in the code.

7. The method of claim 2, further comprising programming the code as one of a function or macro that employs the variable dividend as an input and returns an integer result corresponding to the ceil(x/C) function, wherein x is the variable dividend and C is the constant denominator.

8. The method of claim 2, further comprising programming the code as one of a function or macro that employs the variable dividend as an input and returns an integer result corresponding to the floor(x/C) function, wherein x is the variable dividend and C is the constant denominator.

9. A method, comprising:
selecting a constant defining a fixed-sized cell;
determining parameters to be employed in a combination of multiplication, shift, and optional add operations on a compute engine to perform an integer division operation using the constant as a divisor and a variable size for a packet or frame size as a dividend;
programming code to be executed on the compute engine to determine a minimum number of fixed-size cells the data from a variable-size packet or frame will fit into, the code to perform an integer division operation using multiplication, shift and optional add instructions, the multiplication and shift instructions employing the parameters that are determined; and
in response to receiving a packet or frame of variable size;
determining the size of the packet or frame; and
executing the code to determine a minimum number of fixed-size cells in which to store the data for the packet or frame.

10. The method of claim 9, further comprising:
loading the code on board a network processor including a plurality of compute engines; and
executing the code on at least one of the compute engines.

11. The method of claim 10, further comprising:
loading the code into a respective control store for said at least one of the compute engines during an initialization operation for an apparatus that employs the network processor.

12. The method of claim 9, further comprising:
defining a maximum size for the packet or frame; and
determining a minimal multiplier and shift instruction to produce the same result as a corresponding mathematical integer division operation on a variable-sized dividend using the constant divisor, wherein the variable-size dividend is less than or equal to the maximum size.

13. The method of claim 9, further comprising:
employing the equation,
ceil(x/C)=(((x*floor(K)−1)>>n)+1),
to determine the parameters to be employed in the multiplication, shift, and optional add instructions, wherein x is the variable packet or frame size, C is the constant divisor, n defines the number of bits to shift, and K=(2ⁿ/C).

14. The method of claim 13, further comprising determining a minimum value for n in consideration of a maximum value defined for x.

15. The method of claim 9, further comprising:
employing the equation,
floor(x/C)=((x*ceil(K))>>n)
to determine the parameters to be employed in the multiplication, shift, and optional add instructions, wherein x is the variable packet or frame size, C is the constant divisor, n defines the number of bits to shift, and K=(2ⁿ/C).

16. The method of claim 15, further comprising determining a minimum value for n in consideration of a maximum value defined for x.

17. A machine-accessible medium to provide instructions that, if executed, perform operations comprising:
determining a minimal multiplier and shift instruction to enable an integer division operation to be performed using a reciprocal multiplication operation, wherein the reciprocal multiplication operation produces the same result as an integer division operation would produce given a variable dividend and a constant divisor.

18. The machine-accessible medium of claim 17, wherein the minimal multiplier and shift instruction are determined in consideration of a maximum value for the variable dividend.

19. The machine-accessible medium of claim 18, to provide further instructions to perform operations comprising:
presenting an interface to enable a user to input values for the constant divisor and the maximum value for the variable dividend.

20. The machine-accessible medium of claim 17, wherein the minimal shift instruction is determined using instructions to implement the mathematical ceil( ) function operating on K, wherein K=(2ⁿ/C), and n corresponds to the number of bits to be shifted.

21. The machine-accessible medium of claim 17, wherein the minimal shift instruction is determined using instructions to implement the mathematical floor( ) function operating on K, wherein K=(2ⁿ/C), and n corresponds to the number of bits to be shifted.

22. An apparatus, comprising:
an interconnect comprising a plurality of command and data buses;
a plurality of compute engines, communicatively-coupled to the interconnect; and
a memory, operatively-coupled to at least one of the plurality of compute engines, in which microcode is stored, the microcode including multiplication and shift instructions to perform a software-based integer division operation on a variable dividend and constant divisor using reciprocal multiplication, wherein the multiplication and shift instructions comprise minimum multiplication and shift instructions to obtain the same result as the integer division operation would produce.

23. The apparatus of claim 22, wherein the microcode is employed to determine a minimum number of cells needed to store data corresponding to a given variable-size packet or frame being processed by the apparatus.

24. The apparatus of claim 23, wherein a first portion of the data is to be stored in a first cell having a first size, and wherein the microcode is employed to:
determine an amount of data to be stored in the first cell; and
determine a minimum number of additional cells required to store the remaining data included in the packet or frame that is not stored in the first cell, each of the additional cells having a second size.

25. The apparatus of claim 22, wherein the microcode comprises one of a function or macro that employs a variable dividend as an input and returns an integer result corresponding to the ceil(x/C) function, wherein x is the variable dividend and C is the constant denominator.

26. The apparatus of claim 22, wherein the microcode comprises one of a function or macro that employs a variable dividend as an input and returns an integer result corresponding to the floor(x/C) function, wherein x is the variable dividend and C is the constant denominator.

27. A network line card, comprising:
a backplane interface
a network processor, operatively coupled to the backplane interface and including,
a chassis interconnect comprising a plurality of command and data buses;
a plurality of compute engines, communicatively-coupled to the chassis interconnect; and
a non-volatile memory, communicatively coupled to the network processor, having microcode stored therein, the microcode including multiplication and shift instructions to perform a software-based integer division operation on a variable dividend and constant divisor using reciprocal multiplication, wherein the multiplication and shift instructions comprise minimum multiplication and shift instructions to obtain the same result as the integer division operation would produce.

28. The network line card of claim 27, further comprising:
a media switch fabric interface, comprising a portion of the backplane interface, communicatively coupled to the chassis interconnect, and wherein the microcode is employed to determine a minimum number of cells needed to store data corresponding to a given variable-size packet or frame received by the network processor via the media switch fabric interface.

29. The network line card of claim 28, wherein a first portion of the data for a packet or frame is to be stored in a first cell having a first size, and wherein the microcode is employed to:
determine an amount of data to be stored in the first cell; and
determine a minimum number of additional cells required to store the remaining data included in the packet or frame that is not stored in the first cell, each of the additional cells having a second size.

30. The network line card of claim 26, wherein the network processor further includes:
a general purpose processor, coupled to the chassis interconnect and providing a communication interface via which the non-volatile memory is linked in communication with the network processor.
